(19) United States
(12) Patent Application Publication
(10) Pub. No.: US 2020/0201568 A1
(43) Pub. Date: Jun. 25, 2020

(54) EXCEPTION HANDLING BASED ON RESPONSES TO MEMORY REQUESTS IN A MEMORY SUBSYSTEM

(71) Applicant: Micron Technology, Inc., Boise, ID (US)

(72) Inventors: Kihoon Park, Cupertino, CA (US); Lyle E. Adams, San Jose, CA (US)

(21) Appl. No.: 16/228,460

(22) Filed: Dec. 20, 2018

(51) Int. Cl. G06F 3/06

(52) U.S. Cl. CPC G06F 3/0659; G06F 3/0673; G06F 3/0653; G06F 3/0604

(57) ABSTRACT

A method is described, which includes receiving, by firmware of a memory subsystem, a memory request that requests access to a set of memory components managed by a hardware controller of the memory subsystem and transmitting a sub-request in response to receipt of the memory request. The method further includes receiving, by the firmware from the hardware controller, status information describing the current operating state of the hardware controller at the time of receipt of the sub-request, wherein the status information is transmitted by the hardware controller in response to the sub-request and determining, by the firmware, whether the status information indicates that the hardware controller is operating under an exception condition.

### TECHNICAL FIELD

The present disclosure generally relates to a memory subsystem, and more specifically, relates to exception handling based on responses to memory requests in a memory subsystem.

### BACKGROUND ART

A memory subsystem can be a memory module, such as a dual in-line memory module (DIMM), a small outline DIMM (SO-DIMM), or a non-volatile dual in-line memory module (NVDIMM). A memory subsystem can be a storage system, such as a solid-state drive (SSD), or a hard disk drive (HDD). A memory subsystem can include one or more memory components that store data. The memory components can be, for example, non-volatile memory components and volatile memory components. In general, a host system can utilize a memory subsystem to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory subsystem in accordance with some embodiments of the present disclosure.

FIG. 2 illustrates interactions between a host system, firmware, and a hardware controller in accordance with some embodiments of the present disclosure.

FIG. 3 illustrates an example status information table in accordance with some embodiments of the present disclosure.

FIG. 4 is a flow diagram of an example method to process memory requests based on the operational state of the hardware controller in accordance with some embodiments of the present disclosure.

FIG. 5 is a flow diagram of another example method to process memory requests based on the operational state of the hardware controller in accordance with some embodiments of the present disclosure.

FIG. 6 is a block diagram of an example computer system in which embodiments of the present disclosure can operate.

### DETAILED DESCRIPTION

Aspects of the present disclosure are directed to a hardware controller, which manages memory components and provides status information as responses to communications from firmware in a memory subsystem. A memory subsystem is also hereinafter referred to as a “memory device”. Examples of storage devices include a solid-state drive (SSD), a flash drive, a universal serial bus (USB) flash drive, and a hard disk drive (HDD). Another example of a memory sub-system is a memory module that is coupled to the CPU via a memory bus. Examples of memory modules include a dual in-line memory module (DIMM), a small outline DIMM (SO-DIMM), a non-volatile dual in-line memory module (NVDIMM), etc. In some embodiments, the memory subsystem is a hybrid memory/storage subsystem. In general, a host system can utilize a memory subsystem that includes one or more memory components. The host system can provide data to be stored at the memory subsystem and can request data to be retrieved from the memory subsystem.

Traditional memory subsystems include firmware and a hardware controller for managing memory components (e.g., memory cells). The firmware processes memory requests (e.g., write/store and read data commands/requests) and communicates with the hardware controller for fulfillment of the memory requests. The hardware controller performs operations in relation to the memory components (e.g., error correction on segments of the memory components, setting/resetting cells, etc.) based on communications from the firmware. When an exception occurs, or the hardware controller is otherwise experiencing/operating under an exception condition, the firmware determines/detects the occurrence of the exception condition to properly manage current and future memory requests. For example, the hardware controller and the firmware must terminate or otherwise complete all pending memory requests upon performance of a reset operation (e.g., an operation that causes the memory subsystem to be in a specific predetermined state at the end of the operation/sequence.). Without knowledge of the current state of the hardware controller, the firmware can continually send requests to the hardware controller. The requests can build-up when the hardware controller is resetting or is otherwise experiencing an exception condition (e.g., the link between the memory components and the hardware controller is down based on the reset operation or another exception condition, which prevents memory requests from being completed). Conventionally, to ensure that there are no pending memory requests during an exception condition, the firmware queries the status of the hardware controller repeatedly while processing a memory request. For example, after a write request from a host system has been fetched/received, the firmware transmits a query to the hardware controller requesting status of the hardware controller (e.g., whether the hardware controller is experiencing an exception condition). If the hardware controller indicates to the firmware that the hardware controller is experiencing an exception condition, the firmware aborts the current memory request (i.e., the write request). Conversely, after the firmware determines that the hardware controller is not experiencing an exception condition, the firmware transmits (1) a move data sub-request to the hardware controller to move data based on the fetched write request and (2) a processed sub-request to determine whether the hardware controller has begun processing the move data request. Afterward, the firmware again transmits a query to the hardware controller requesting status of the hardware controller (e.g., whether the hardware controller is experiencing an exception condition). Similar to the process described above, the firmware determines whether to abort the current memory request (i.e., the write request) or continue processing the current memory request (e.g., transmit a command completion sub-request to determine whether processing of the move data request has been completed) based on the determined status of the hardware controller.

As described above, firmware processing of memory requests requires repeated explicit status queries to the hardware controller. These repeated status queries occur along the main command handling path performed by the firmware (i.e., the logical control path invoked while the hardware controller is operating normally) and introduce significant overhead to processing memory requests (e.g., time devoted to querying and awaiting responses to queries). Accordingly, although it is unlikely that the hardware controller will be experiencing an exception condition, the firmware must incur a significant amount of overhead for each memory request to warrant against the possibility of an exception condition.

Aspects of the present disclosure address the above and other deficiencies by having a hardware controller provide status information to the firmware of a memory subsystem in response to communications from the firmware. For example, in response to each request/sub-request from the firmware of a memory subsystem corresponding to a memory request, a hardware controller provides status information to the firmware. For example, the firmware transmits one or more sub-requests to the hardware controller corresponding to a single memory request. The sub-requests each seek to satisfy, perform, respond to, or otherwise accomplish the entire memory request or a portion of the memory request. In response to each sub-request (e.g., a move data sub-request, a command completion sub-request, etc.), the hardware controller returns status information to the firmware indicating the current operating status of the hardware controller. The status information is explicit and can include two or more possible values. For instance, the status information can be represented by multiple bits of data. In this example, when the status information has a value of zero (e.g., the status information has a value of “0000”), the hardware controller is operating normally. However, any other value of the status information indicates a specific exception of the hardware controller. For example, the value of one (e.g., the status information has the value of “0001”) indicates that the hardware controller is performing a reset operation; the value of two (e.g., the status information has the value of “0010”) indicates that the hardware controller is experiencing a first exception condition; the value of three (e.g., the status information has the value of “0011”) indicates that the hardware controller is experiencing a second exception condition; etc. In other embodiments, the status information can be represented by a single bit, which indicates when the hardware controller is operating normally (e.g., the single bit of the status information has a value of “0”) or is operating under an exception condition (e.g., the single bit of the status information has a value of “1”). When the single bit of status information indicates that the hardware controller is operating under an exception condition, the firmware can request the hardware controller provide exception information that indicates the specific exception condition or the hardware controller can automatically transmit exception information to the firmware in response to the single bit of status information indicating that the hardware controller is operating under an exception condition.

As will be described in greater detail below, the status information and/or the exception information can be used for performing exception operations associated with the exception condition. By requiring the hardware controller to transmit status information and/or exception information to the firmware in response to each sub-request of a memory request, the firmware no longer needs to separately query the hardware controller for status information. Accordingly, time devoted by the firmware to handling exception conditions can be at least partially moved outside the main command handling path of the firmware. As a result, there is minimum impact on memory requests that are normally processed by the memory subsystem (i.e., memory requests that are received by the firmware and hardware controller when the hardware controller is operating normally and not under an exception condition).

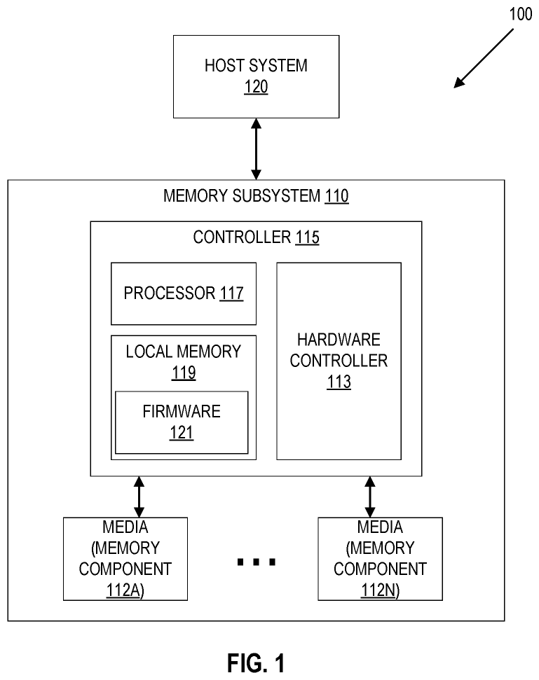

FIG. 1 illustrates an example computing environment 100 that includes a memory subsystem 110 in accordance with some embodiments of the present disclosure. The memory subsystem 110 can include media, such as memory components 112A to 112N. The memory components 112A to 112N can be volatile memory components, non-volatile memory components, or a combination of such. In some embodiments, the memory subsystem is a storage system. An example of a storage system is an SSD. In some embodiments, the memory subsystem 110 is a hybrid memory/storage subsystem. In general, the computing environment 100 can include a host system 120 that uses the memory subsystem 110. For example, the host system 120 can write data to the memory subsystem 110 and read data from the memory subsystem 110.

The host system 120 can be a computing device such as a desktop computer, laptop computer, network server, mobile device, or such computing device that includes a memory and a processing device. The host system 120 can include or be coupled to the memory subsystem 110 so that the host system 120 can read data from or write data to the memory subsystem 110. The host system 120 can be coupled to the memory subsystem 110 via a physical host interface. As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory subsystem 110. The host system 120 can further utilize an NVM Express (NVMe) interface to access the memory components 112A to 112N when the memory subsystem 110 is coupled with the host system 120 by the PCIe interface. The physical host interface can provide an interface for passing control, address, data, and other signals between the memory subsystem 110 and the host system 120.

The memory components 112A to 112N can include any combination of the different types of non-volatile memory components and/or volatile memory components. An example of non-volatile memory components includes a negative-and (NAND) type flash memory. Each of the memory components 112A to 112N can include one or more arrays of memory cells such as single level cells (SLCs) or multi-level cells (MLCs) (e.g., triple level cells (TLCs) or quad-level cells (QLCs)). In some embodiments, a particular memory component can include both an SLC portion and an MLC portion of memory cells. Each of the memory cells can store one or more bits of data (e.g., data blocks) used by the host system 120. Although non-volatile memory components such as NAND type flash memory are described, the memory components 112A to 112N can be based on any other type of memory such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. Furthermore, the memory cells of the memory components 112A to 112N can be grouped as memory pages or data blocks that can refer to a unit of the memory component used to store data.

The memory system controller 115 (hereinafter referred to as “controller”) can communicate with the memory components 112A to 112N to perform operations such as reading data, writing data, or erasing data at the memory components 112A to 112N and other such operations. The controller 115 can include hardware such as one or more integrated circuits and/or discrete components, a buffer memory, or a combination thereof. The controller 115 can be a microcontroller, special purpose logic circuitry (e.g., a field programmable gate array (FPGA), an application specific integrated circuit (ASIC), etc.), or another suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory subsystem 110, including handling communications between the memory subsystem 110 and the host system 120. In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the controller 115, in another embodiment of the present disclosure, a memory subsystem 110 may not include a controller 115, and may instead rely upon external control (e.g., provided by an external host, or by a processor or controller separate from the memory subsystem).

In general, the controller 115 can receive commands or operations from the host system 120 and can convert the commands or operations into instructions or appropriate commands to achieve the desired access to the memory components 112A to 112N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112A to 112N. The controller 115 can further include host interface circuitry to communicate with the host system 120 via the physical host interface. The host interface circuitry can convert the commands received from the host system into command instructions to access the memory components 112A to 112N as well as convert responses associated with the memory components 112A to 112N into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the controller 115 and decode the address to access the memory components 112A to 112N.

The memory subsystem 110 includes a hardware controller 113 that processes and executes commands to manage data stored in the memory components 112A to 112N. The hardware controller 113 can be formed or can be defined by one or more hardware elements, including an application-specific integrated circuit (ASIC).

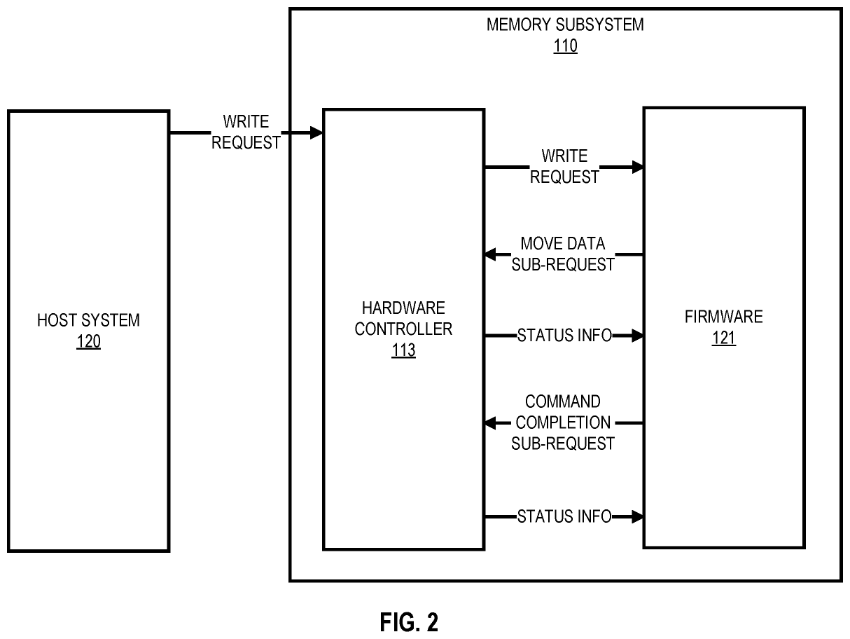

In some embodiments, the local memory 119 can store firmware 121 that is executed by the processor 117. When executed by the processor 117, the firmware 121 processes memory requests (e.g., write/store or read requests) corresponding to the memory components 112A to 112N. For example, FIG. 2 shows interactions between the host system 120, the firmware 121, and the hardware controller 113, according to one example embodiment. As shown in FIG. 2, the host system 120 can transmit a write request that is received by the hardware controller 113 of the memory subsystem 110. The hardware controller 113 forwards/transmits or otherwise makes the write request available to the firmware 121. Based on the write request from the host system 120, the firmware 121 transmits a move data sub-request (i.e., a sub-request to move data into a location/address in the memory components 112A to 112N as indicated by the write request) to the hardware controller 113. In response to receipt and/or processing of the move data sub-request, the hardware controller 113 transmits status information to the firmware 121. The status information indicates the current status of the hardware controller 113 (i.e., the status of the hardware controller 113 when the move data sub-request). Similarly, the firmware 121 transmits a command completion sub-request (i.e., a sub-request to determine/query whether data has been moved in appropriate positions within the memory components 112A to 112N as indicated by the write request and/or the move data sub-request) to the hardware controller 113. In response to receipt and/or processing of the command completion sub-request, the hardware controller 113 transmits status information to the firmware 121. The status information indicates the current status of the hardware controller 113 (i.e., the status of the hardware controller 113 when the command completion sub-request is received).

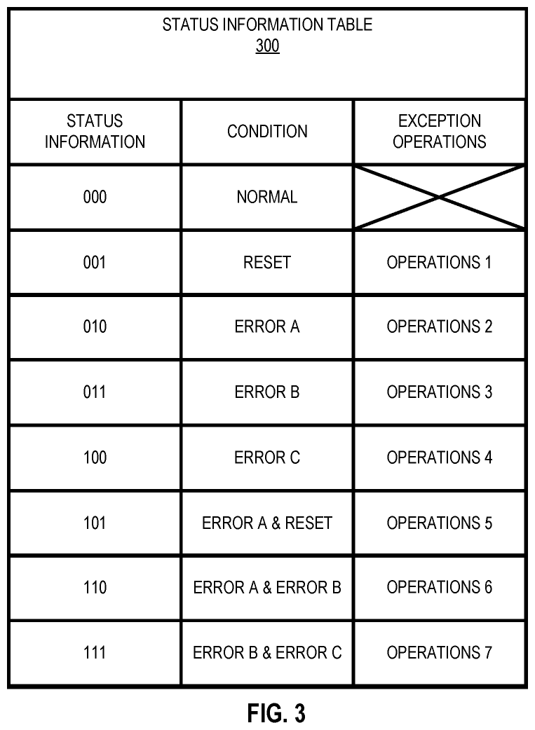

The status information can be represented using one or more bits. In one embodiment, when the status information is represented by multiple bits, which can collectively represent four or more values (e.g., two bits represent four values, three bits represent eight values, etc.), one value in the one or more values represents a normal operating condition (i.e., the hardware controller 113 is operating normally and there are no detected exception conditions) and each of the remaining values can correspond to possible exception conditions experienced by the hardware controller 113. For example, FIG. 3 shows an example status information table 300 where the status information values are used as indices for exception conditions and sets of exception operations, according to one example embodiment. In this example, status information is represented with three bits and each value for the status information corresponds to either a normal operating condition (e.g., the status information has a value of “000”) or an exception condition (e.g., the status information has a value of “001” through “111”). When the status information from the hardware controller 113 indicates a normal condition (e.g., the status information has a value of “000”), the firmware 121 continues using the main command handling path (i.e., the logical control path invoked while the hardware controller 113 is operating normally). In contrast, when the status information from the hardware controller 113 indicates an exception condition (e.g., the status information has a value of “001” through “111”), the firmware 121 deviates from the main command handling path and performs one or more exception operations associated with the exception condition. For example, the example status information table 300 of FIG. 3 shows exception operations associated with each exception condition. Upon the firmware receiving status information from the hardware controller 113 corresponding to an exception condition (i.e., status information with a value of “001” through “111”), associated exception operations are performed instead of the main command handling path of the firmware 121. In some embodiments, exception operations can include retrying the current memory request, aborting the current memory request, and/or one or more other remediation operations. Further details with regards to the operations of the hardware controller 113 and the firmware 121 are described below.

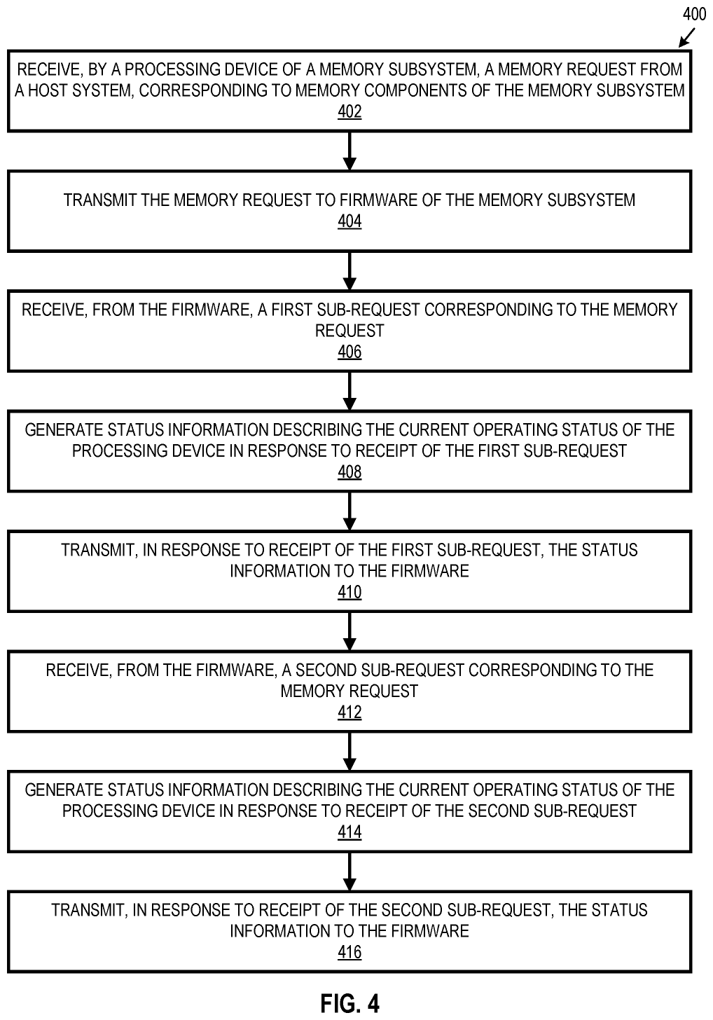

FIG. 4 is a flow diagram of an example method 400 to process memory requests based on the operational state of the hardware controller 113, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the hardware controller 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 402, the processing device (e.g., the hardware controller 113) receives a memory request from the host system 120. For example, the memory request is a read request from the host system 120, which requests data from the memory components 112A to 112N. In another example, the memory request is a write request from the host system, which seeks to write data to memory components 112A to 112N. As noted above, the processing device can be the hardware controller 113 that works with the firmware 121 to process memory requests.

At block 404, the processing device transmits or otherwise makes the memory request available to the firmware 121 of the memory subsystem 110. As described herein, although the processing device initially receives the memory request, the firmware 121 manages the processing device for fulfillment of the memory request via the memory components 112A to 112N. In particular, the firmware 121 transmits one or more sub-requests to the processing device to satisfy, perform, respond, or otherwise accomplish the memory request.

At block 406, the processing device receives a first sub-request from the firmware 121. The first sub-request is based on the memory request received from the host system 120 at block 402. For example, when the memory request is a write request, the first sub-request can be a move data sub-request, which requests the processing device to move data to a location/address in the memory components 112A to 112N as indicated by the write request. When the memory request is a read request, the first sub-request can be a read data sub-request to read data from the memory components 112A to 112N at the location/address indicated by the read request.

At block 408, the processing device generates status information corresponding to the current operating state of the processing device in response to receipt of the first sub-request. As described above and shown in FIG. 3, the status information can be represented by a set of bits and each value for the set of bits corresponds to a different operational state of the processing device. For example, when the status information has a value of zero (e.g., the status information is represented by three bits, which are set/generated to have a value of “000”), the status information indicates that the processing device is operating in a normal state (i.e., no exceptions have been detected). In contrast, when the status information has another value (e.g., the status information has a value of “011”), the status information indicates that the processing device is operating under an exception condition (e.g., a reset is being performed by the processing device, an error has been detected by the processing device, etc.).

At block 410, the processing device transmits the status information to the firmware 121 in response to receipt of the first sub-request. The firmware 121 can thereafter utilize the status information for adjusting processing of the memory request. For example, when the status information indicates that the processing device is operating under an exception condition, the firmware 121 can perform one or more exception operations (e.g., exception operations associated with the exception condition, as shown in the example status information table 300 of FIG. 3). In contrast, when the status information indicates that the processing device is operating normally, the firmware 121 can continue performing based on the main command handling path of the firmware 121.

In some embodiments, the status information is represented by a single bit. In these embodiments, when the processing device is operating normally, the single bit of the status information has a value of “0”. In contrast, when the processing device is operating under an exception condition, the single bit of the status information has a value of “1”. When the single bit of status information indicates that the hardware controller is operating under an exception condition, the firmware 121 can request the processing device provide exception information that indicates the specific exception condition or the processing device can automatically transmit exception information to the firmware 121 in response to the single bit of status information indicating that the processing device is operating under an exception condition. Accordingly, the processing device can generate and transmit exception information to the firmware 121 following the status information. In this embodiment, the firmware 121 can use the exception information in lieu of or in addition to the status information to determine a set of exception operations to perform.

In some embodiments, when the status information indicated that the processing device is operating under an exception condition, the method 400 can conclude. However, in some embodiments, particularly in which the status information indicated that the processing device is operating normally (i.e., no detected exception conditions), the method 400 can continue to block 412.

At block 412, the processing device receives a second sub-request from the firmware 121. Similar to the first sub-request, the second sub-request is based on the memory request received from the host system 120 at block 402. For example, when the memory request is a write request, the second sub-request can be a command completion sub-request to determine if the move data sub-request, which is a sub-request to move data to a location/address in the memory components 112A to 112N, has been completed.

At block 414, the processing device generates status information corresponding to the current operating state of the processing device in response to receipt of the second sub-request. In some embodiments, the status information is generated in the same fashion as described in relation to block 408. However, the status information generated at block 414 reflects the state of the processing device when the processing device receives the second sub-request, whereas the status information generated at block 408 reflects the state of the processing device when the processing device receives the first sub-request. Accordingly, the status information generated at block 414 can be different from the status information generated at block 408.

At block 416, the processing device transmits the status information to the firmware 121 in response to receipt of the second sub-request. Again, the firmware 121 can thereafter utilize the status information for adjusting processing of the memory request. For example, when the status information indicates that the processing device is operating under an exception condition, the firmware 121 can perform one or more exception operations (e.g., exception operations associated with the exception condition, as shown in the example status information table 300 of FIG. 3). In contrast, when the status information indicates that the processing device is operating normally, the firmware 121 can continue performing the main command handling path of the firmware 121. Further, as described above, the processing device can generate and transmit exception information following the status information. In this embodiment, the firmware 121 can use the exception information in lieu of or in addition to the status information to determine a set of exception operations to perform.

Accordingly, as described above, the method 400 returns status information and/or exception information describing/indicating the current operating status of the processing device (e.g., the hardware controller 113) in response to requests/sub-requests from the firmware 121. As will be described in detail below, the firmware 121 can use this status information to adjust processing of an associated memory request (e.g., perform one or more exception operations that are separate from the main command handling path performed by the firmware 121). Further, by requiring the processing device to transmit status information to the firmware 121 in response to each request/sub-request of the firmware 121, the firmware 121 no longer needs to separately query the processing device for status information. Accordingly, time devoted by the firmware 121 to handling exceptions can be at least partially moved outside the main command handling path of the firmware 121.

Although described in relation to two sub-requests, the method 400 can be performed in relation to any number of sub-requests received from the firmware 121. For example, the firmware 121 can transmit one or more sub-requests to fulfill the memory request.

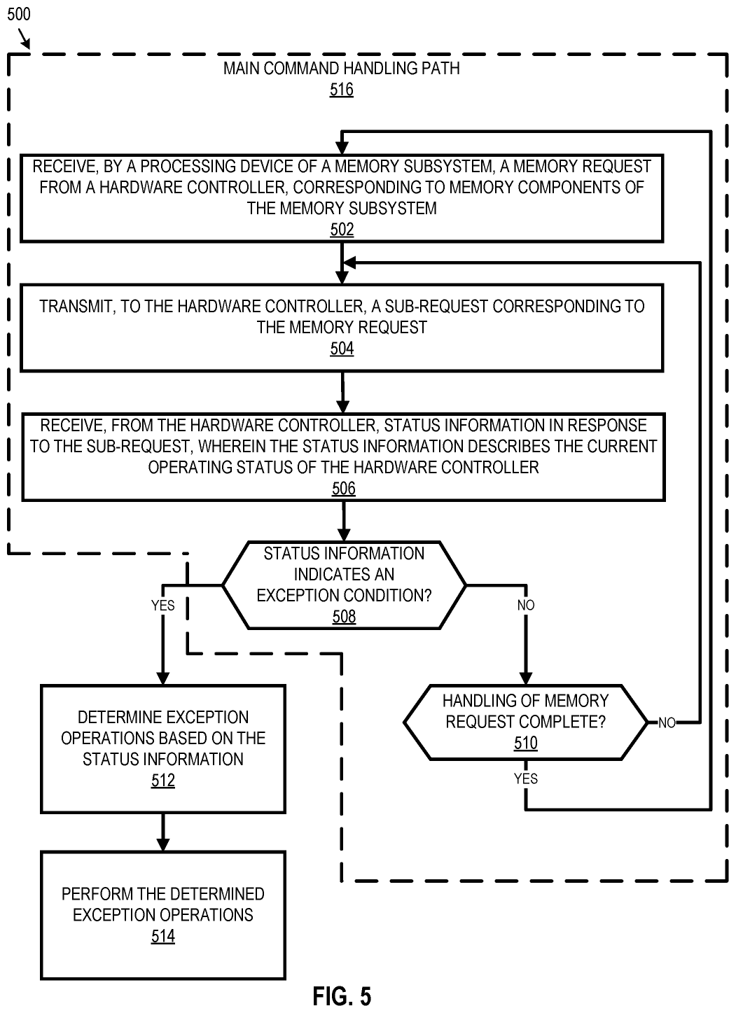

FIG. 5 is another flow diagram of an example method 500 to process memory requests based on the operational state of the hardware controller 113, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the firmware 121 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 502, the processing device receives a memory request from the hardware controller 113. The memory request can be originally received by the hardware controller 113 from the host system 120 and is thereafter passed to the processing device for receipt at block 502. The memory request corresponds to the memory components 112A to 112N. For example, the memory request can be a read request (i.e., a request to read data from the memory components 112A to 112N and return the read data to the host system 120) or a write/store request (i.e., a request to write data received from the host system 120 to the memory components 112A to 112N). In one embodiment, the memory request received by the processing device at block 502 corresponds to the memory request transmitted by the processing device (e.g., the hardware controller 113) at block 404 of the method 400.

At block 504, the processing device transmits a sub-request to the hardware controller 113. The sub-request corresponds to the memory request received by the processing device at block 502. The sub-request seeks to satisfy, perform, respond, or otherwise accomplish the entire memory request or a portion of the memory request. For example, the sub-request can correspond to the first sub-request transmitted at block 406 of the method 400 or the second sub-request transmitted at block 412 of the method 400.

At block 506, the processing device receives status information from the hardware controller 113. The status information describes/indicates the current operating state of the hardware controller 113. In one embodiment, the status information can correspond to the status information generated at blocks 408 or 414 of the method 400 and transmitted at blocks 410 or 416, respectively, of the method 400.

At block 508, the processing device determines if the status information received from the hardware controller 113 corresponds to an exception condition. For example, when the status information indicates a reset operation is being performed by the hardware controller 113 (e.g., the status information has a value “001” based on the status information table 300 of FIG. 3), the processing device determines that the status information corresponds to an exception condition at block 508. Conversely, when the status information indicates a normal condition (e.g., the status information has a value “00” based on the status information table 300 of FIG. 3), the processing device determines that the status information does not correspond to an exception condition at block 508. In response to the processing device determining at block 508 that the status information does not correspond to an exception condition, the method 500 moves to block 510.

At block 510, the processing device determines if processing of the memory request is complete. In response to the processing device determining at block 510 that processing of the memory request is complete, the method 500 moves to block 502 to await receipt of a new memory request. Conversely, upon the processing device determining at block 510 that processing of the memory request is incomplete, the method 500 moves to block 504 to transmit another sub-request, corresponding to the memory request, to the hardware controller 113.

Returning to block 508, in response to the processing device determining at block 508 that the status information corresponds to an exception condition, the method 500 moves to block 512. At block 512, the processing device determines a set of exception operations to perform in response to the detected exception condition. In one embodiment, the processing device compares the status information against a status information table at block 512 to determine a set of exception operations associated with the detected exception condition. For example, when the status information has a value of “011”, the processing device can compare this status information value with the status information table 300 of FIG. 3 to determine “operations 3” corresponds to the detected exception condition. Accordingly, the status information is used to index into a status information table to determine a set of exception operations (i.e., compare the status information with index values of a status information table to determine a match).

In some embodiments, the status information is represented by a single bit. In these embodiments, the status information can indicate that the processing device is operating normally (e.g., the status information has a value of “0”) or is operating under an exception condition (e.g., the status information has a value of “1”). However, the status information does not indicate a specific exception condition from a set of possible exception conditions. Based on this lack of information, the processing device can determine the set of exception operations to perform by transmitting an exception condition query to the hardware controller 113 at block 512. In response to the exception condition query, the hardware controller 113 generates exception information, which can be represented with more bits in comparison to the status information. For example, when the status information, which indicated an exception condition, is represented with a single bit, the exception information can be represented using one or more bits. In this example, the value zero (i.e., the exception information has a value of “0”, “00”, “000”, etc.), can indicate a type of exception condition instead of a normal condition as shown in the status information table 300 of FIG. 3.

At block 514, the processing device performs the determined exception operations. For example, when the exception condition is designated as a retriable exception condition (e.g., the exception condition corresponds to (1) resources of the hardware controller 113 and/or the memory components 112A to 112N being temporarily depleted/in-use or (2) the hardware controller 113 and/or the memory components 112A to 112N overheating), the set of exception operations can include retrying the memory request or one or more of the sub-requests associated with the memory request after a period of delay. In some embodiments, the set of exception operations can include aborting the memory request. For example, when the exception condition is (1) the hardware controller 113 attempting to perform a reset operation, (2) the host system 120 cancelling the memory request, or (3) the processing device indicating a detected error in the hardware controller 121, the set of exception operations can include aborting the memory request.

As described above, the processing device (e.g., the firmware 121) receives status information describing/indicating the current operating status of the hardware controller 113 in response to requests/sub-requests transmitted by the processing device to the hardware controller 113. The processing device uses this status information to adjust processing of an associated memory request (e.g., perform one or more exception operations that are separate from the main command handling path 516 performed by the firmware 121). By requiring the hardware controller 113 to transmit status information to the processing device in response to each request/sub-request of the processing device, the processing device no longer needs to separately query the hardware controller 113 for status information. Accordingly, time devoted by the processing device to handling exceptions can be at least partially moved outside the main command handling path 516 of the processing device (i.e., the logical control path invoked during normal memory request handling, which may sometimes be referred to as the main memory request handling/processing path).

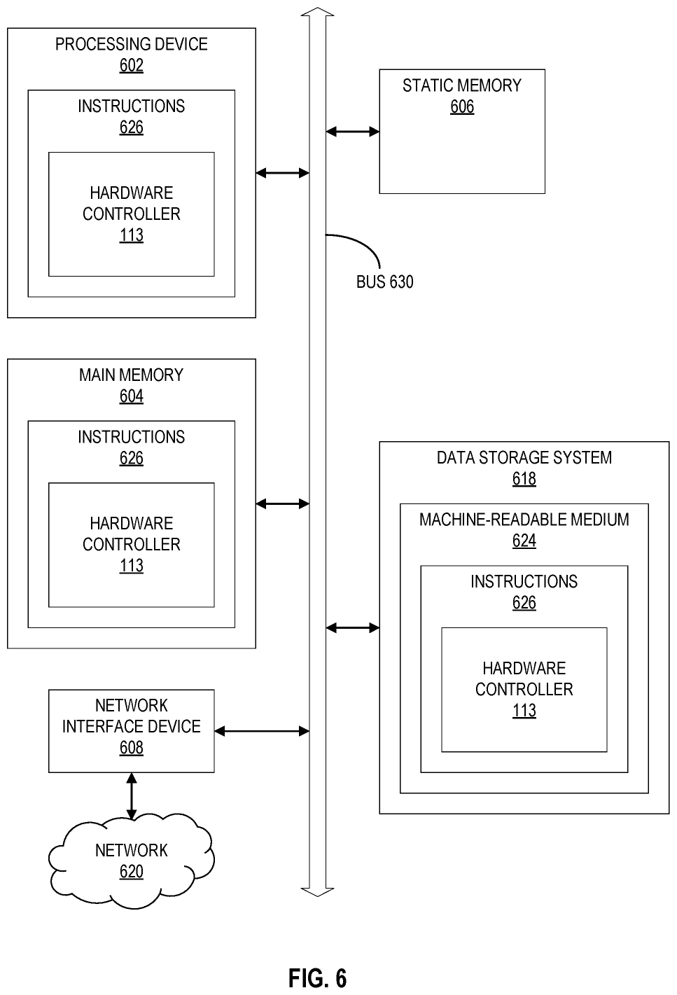

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the hardware controller 113 and the firmware 121 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory subsystem 110 of FIG. 1.

In one embodiment, the instructions 626 include instructions to implement functionality corresponding to a hardware controller and/or firmware (e.g., the hardware controller 113 and the firmware 121 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. For example, a computer system or other data processing system, such as the controller 115, can carry out the computer-implemented methods 400 and 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, by firmware of a memory subsystem, a memory request that requests access to a set of memory components managed by a hardware controller of the memory subsystem;
transmitting, by the firmware to the hardware controller, a sub-request in response to receipt of the memory request;
receiving, by the firmware from the hardware controller, status information describing the current operating state of the hardware controller at the time of receipt of the sub-request, wherein the status information is transmitted by the hardware controller in response to the sub-request; and
determining, by the firmware, whether the status information indicates that the hardware controller is operating under an exception condition.

2. The method of claim 1, further comprising:
performing, by the firmware, a set of exception operations in response to determining that the hardware controller is operating under an exception condition.

3. The method of claim 2, further comprising:
determining, by the firmware in response to determining that the hardware controller is operating under an exception condition, the set of exception conditions by comparing one or more portions of the status information with values in a status information table,
wherein the exception operations include one of retrying the memory request and aborting the memory request.

4. The method of claim 2, further comprising:
determining, by the firmware in response to determining that the hardware controller is operating under an exception condition, the set of exception conditions by receiving exception information from the hardware controller following receipt of the status information and comparing one or more portions of the exception information with values in a status information table,
wherein the exception operations include one of retrying the memory request and aborting the memory request.

5. The method of claim 1, wherein the memory request is one of a read request to read data from the set of memory components and a write request to write data to the set of memory components, and
wherein the sub-request is to cause the hardware controller to accomplish the memory request or a portion of the memory request.

6. The method of claim 1, wherein the status information is represented by two or more bits, and wherein a first value of the two or more bits indicates that the hardware is operating normally, a second value of the two or more bits indicates that the hardware is operating under a first exception condition, and a third value of the two or more bits indicates that the hardware controller is operating under a second exception condition.

7. A method comprising:
receiving, by a hardware controller of a memory subsystem, a sub-request from firmware of the memory subsystem, wherein the sub-request corresponds to a memory request from a host system;
generating, by the hardware controller in response to receipt of the sub-request, status information describing the current operating state of the hardware controller; and
transmitting, by the hardware controller in response to receipt of the sub-request, the status information to the firmware.

8. The method of claim 7, wherein the status information indicates whether the hardware controller is operating normally or whether the hardware controller is operating under an exception condition.

9. The method of claim 8, wherein the exception condition is the hardware controller performing a reset operation.

10. The method of claim 7, wherein the status information is represented by two or more bits and indicates whether the hardware controller is operating normally, operating under a first exception condition, or operating under a second exception condition.

11. The method of claim 7, wherein the status information is represented by a single bit, and
wherein a first value of the status information indicates that the hardware controller is operating normally and a second value of the status information indicates that the hardware controller is operating under an exception condition.

12. The method of claim 11, further comprising:
transmitting, by the hardware controller, exception information to the firmware following transmission of the status information,
wherein a first value of the exception information indicates that the hardware controller is operating under a first exception condition and a second value of the exception information indicates that the hardware controller is operating under a second exception condition.

13. The method of claim 7, wherein the memory request is one of a read request to read data from the set of memory components and a write request to write data to the set of memory components, and
wherein the sub-request is to cause the hardware controller to accomplish the memory request or a portion of the memory request.

14. A non-transitory computer-readable storage medium comprising instructions that, when executed by a processing device, cause the processing device to:
receive a sub-request from firmware of a memory subsystem, wherein the sub-request corresponds to a memory request from a host system;
generate, in response to receipt of the sub-request, status information describing the current operating state of a hardware controller; and
transmit, in response to receipt of the sub-request, the status information to the firmware.

15. The non-transitory computer-readable storage medium of claim 14, wherein the status information indicates whether the hardware controller is operating normally or whether the hardware controller is operating under an exception condition.

16. The non-transitory computer-readable storage medium of claim 15, wherein the exception condition is the hardware controller performing a reset operation.

17. The non-transitory computer-readable storage medium of claim 14, wherein the status information is represented by two or more bits and indicates whether the hardware controller is operating normally, operating under a first exception condition, or operating under a second exception condition.

18. The non-transitory computer-readable storage medium of claim 14, wherein the status information is represented by a single bit, and
wherein a first value of the status information indicates that the hardware controller is operating normally and a second value of the status information indicates that the hardware controller is operating under an exception condition.

19. The non-transitory computer-readable medium of claim 18, wherein the processing device is further to:
transmit exception information to the firmware following transmission of the status information,
wherein a first value of the exception information indicates that the hardware controller is operating under a first exception condition and a second value of the exception information indicates that the hardware controller is operating under a second exception condition.

20. The non-transitory computer-readable storage medium of claim 14, wherein the memory request is one of a read request to read data from the set of memory components and a write request to write data to the set of memory components, and
wherein the sub-request is to cause the hardware controller to accomplish the memory request or a portion of the memory request.
